(19) United States
(12) Patent Application Publication
(10) Pub. No.: US 2008/0057801 A1
(43) Pub. Date: Mar. 6, 2008

(54) BLOCK WALL CONSTRUCTION SYSTEM INCLUDING USE OF CLIP RETAINERS

(76) Inventor: Peter Duffy, Reno, NV (US)

Correspondence Address: IAN F. BURNS & ASSOCIATES, P.O. BOX 71115, RENO, NV, 89570, US

(21) Appl. No.: 11/845,357

(22) Filed: Aug. 27, 2007

Related U.S. Application Data
(60) Provisional application No. 60/824,205, filed on Aug. 31, 2006.

(51) Int. Cl. H01R 13/73

(52) U.S. Cl. 439/894

(57) ABSTRACT

A wall construction system comprising a clip that may hold two block assemblies together in spaced relationship with each other. The clip has attachment means to hold the blocks and spacing means for providing a cavity between the blocks. An insulating block can be inserted between the first and second blocks and held in place by a flange. A reinforcing rod can be placed in between the first and second blocks and is attached to the clip of a curved area. A pourable material, such as concrete, can be filled in the cavity and can be allowed to solidify.

### CROSS REFERENCE TO RELATED APPLICATIONS

This application claims priority to U.S. provisional patent application Ser. No. 60/824,205, filed Aug. 31, 2006, the contents of which is herein incorporated by reference.

### FIELD OF THE INVENTION

The present invention is related to block wall construction. More particularly, the present invention relates to block wall construction system using an injection molded clip to retain interlocking block surfaces spaced relationship with each other.

### BACKGROUND

It is common construction practice to erect building walls, as well as certain categories of free-standing walls, using concrete blocks of a solid rectangular configuration in which each block exhibits a plurality of cavities and external planes at all six sides thereof. Such blocks are, as is well known, laid-up in courses, typically by placing mortar, by towel, on the top of the blocks and then positioning the blocks of the next course upon the lower course.

The building of walls goes back to ancient times when rocks were used. Modern wall building conventionally employs blocks to build decorative, retaining and privacy walls. Conventional techniques, especially where the wall is to retain soil from subsidence or provide a building foundation, use blocks with closed cavities, smooth end walls, and generally planar upper and lower surfaces. The blocks are stacked upon each other with each subsequent layer of blocks overlapping the underlying seams between individual blocks. Because of the smooth surfaces of the blocks, they rely upon mortar, grout or cement to hold them in engagement to each other. To insure that this engagement is permanent and to provide additional strength against lateral forces and earthquake type forces, most conventional block walls employ vertical steel rods and, on many types of construction, horizontal steel rods which communicate to adjacent blocks. The steel reinforcement rods must be threaded through closed cavities of conventional blocks used, and once all the blocks and steel are properly placed, mortar, grout or similar cement-like material can then be filled into the closed cavities. The cementitious material, once dried, will lock the metal bars and the blocks in a fixed engagement with each other.

As is well known, the requirement of placing blocks adjacent to each other in proper spacing to form a layer and repeating the process with each overhead layer supported by underlying layers is tedious. Further, it requires a great expenditure in time and energy on the part of workers, and increased worker skill to complete successfully and aesthetically because of the nuances of engaging adjacent blocks and interwoven steel rods with sufficient cement mortar or grout to form block formed walls. This is especially true when reinforcing bars are employed and interwoven between lower brick layers and those above them. Not only must metal bars be properly placed and interwoven as the wall is built upward, the blocks themselves must be lifted upward above the distal high end of the vertical reinforcing bars, and once there, they must be lowered with the reinforcing bar threaded into the internal cavities of the block. With each block weighing between 28 to 36 pounds, this is a daunting and exhausting task for even the most experienced block builder.

Furthermore, typical conventional concrete blocks have smooth side surfaces and generally planar top and bottom surfaces on which the blocks engage underlying or overlying block layers in a wall. Such construction provides no means to interlock overhead blocks to underlying layers of blocks in the wall. Conventional concrete blocks generally offer no endwall means of engagement to adjacent blocks in a given layer either. Instead, conventional concrete blocks are designed to be aligned in individual layers of adjacent blocks with subsequent layers formed in the same fashion stacked on top of each other.

What is needed in the field of block wall construction are improved systems for constructing block walls. The present invention substantially departs from the conventional concepts and designs of the prior art, and in so doing provides a structurally superior wall that is fully insulated. This in turn provides the builder with a finished surface, inside and out.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide a structurally superior wall;

provide a method and system for building walls that utilizes a pourable material, such as cement or concrete;

provide a method and system for building walls that provides insulation;

provide a method and system for building walls that may have different surfaces;

provide the builder with a finished surface inside and outside of a wall; and

provide a method and system for building that is faster and less expensive than other methods.

These and other advantages may be realized by reference to the remaining portions of the specification, claims, and abstract.

### Brief Description of One Embodiment of the Present Invention

A wall construction system comprising a clip that can fasten together at least two blocks. The clip may be injection molded for inexpensive manufacturing. The clip has attachment means to hold the blocks and spacing means for providing a cavity between the blocks suitable for receiving a pourable material. The blocks may have a channel top and bottom which allow the clip to grip the concrete slabs. The pieces of concrete blocks may have three small grooves running from top to bottom on their interior faces. These grooves accept the side area of the clip to hold either side of the block square to each other and make it rigid which facilitates the true alignment of the finished product. A piece of rigid insulation can be slipped into the interior of the block and is held in place by flanges. The curved area of the clip allows the reinforcing steel to be accepted by the clip and held or locked in place.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of one embodiment of the wall construction system of the present invention.

FIG. 2 is substantially a perspective view of the clip in one embodiment of the present invention.

FIG. 3 is substantially a top view of the wall with the clip holding the blocks in accordance with one embodiment of the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

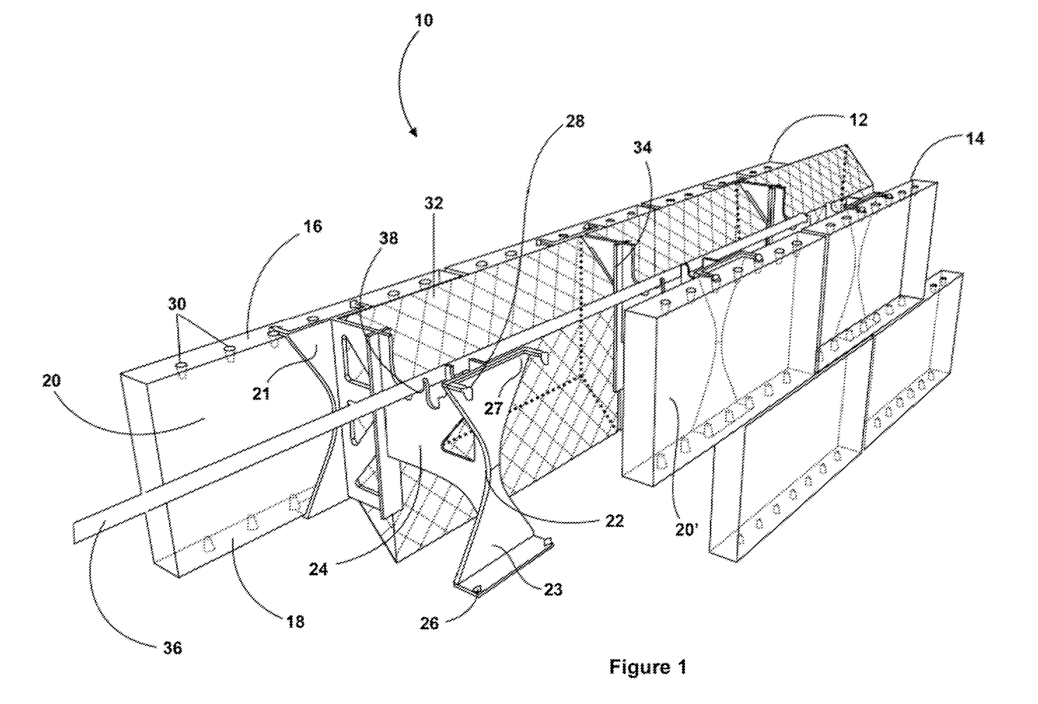

Referring to FIG. 1 a perspective view of a wall construction system is shown, as generally indicated by reference number 10. The wall construction system comprises a first and second block assemblies 12 and 14, each block assembly including, as shown in FIG. 1 with respect to block assembly 12, an upper surface 16, lower surface 18 and an inner surface 20. A clip 22 is used to interlock the block assemblies 12 and 14. Each block of block assembly 12 and 14 may be made from a variety of materials. For example, a block may be made from concrete, ceramic, brick, stone, wood, metal, foam, plastic, etc. The material used to manufacture the blocks may depend on the intended use and the desired esthetic appearance. For example, if the wall is to be used in a house, the exterior blocks may be made of concrete to provide a robust, durable exterior surface while the interior may be made from wood or stone to provide an elegant interior surface. Blocks on a single wall may be made from different materials to provide interesting patterns. Clip 22 may be made by injection molded plastic. In other embodiments, clip 22 is made using fiber reinforced plastic, such as fiber glass, and extruded metal. A first side of the clip 22 is configured to abut the inner surface 20 of the first block assembly 12 and hold the first block assembly 12 in vertical alignment and second side is configured to abut the inner surface 20 of the second block assembly 14 and hold the second block assembly 14 in vertical alignment with the first block assembly 12. A connecting member 24 is attached to the first side 21 and second side 23 of the clip 22 and the connecting member 24 is configured to hold the first and the second sides 21, 23 in a spaced apart parallel relationship, wherein a cavity is formed between the first and second sides 21, 23. A pourable, liquid-like material, such as concrete or cement, can be deposited in the space between the first and second blocks assemblies 12 and 14. After the material is allowed to solidify, it provides a large amount of structural strength and rigidity.

The first and second side 21, 23 of the clip 22 may comprise lower brackets 26 and upper brackets 27. The lower brackets 26 are configured to abut the lower surface 18 of the blocks and upper brackets 27 are configured to abut the upper surface 16 of the blocks. The upper and lower surfaces 16, 18 of the blocks may have receptacles 30 formed therein. Both upper and lower brackets include projections 28 configured to engage the receptacles 30. In an alternative embodiment, upper and lower surface 16 and 18 of the blocks have one or more grooves and projections 28 are configured to engage the grooves. Other attachment devices may be used to attach brackets 26 and 27 to the blocks, such as screws, stables, wire or adhesives. An insulating block 32 can be inserted between the first and second sides of the clip 22. A flange 34 can hold the insulating block 32 in place.

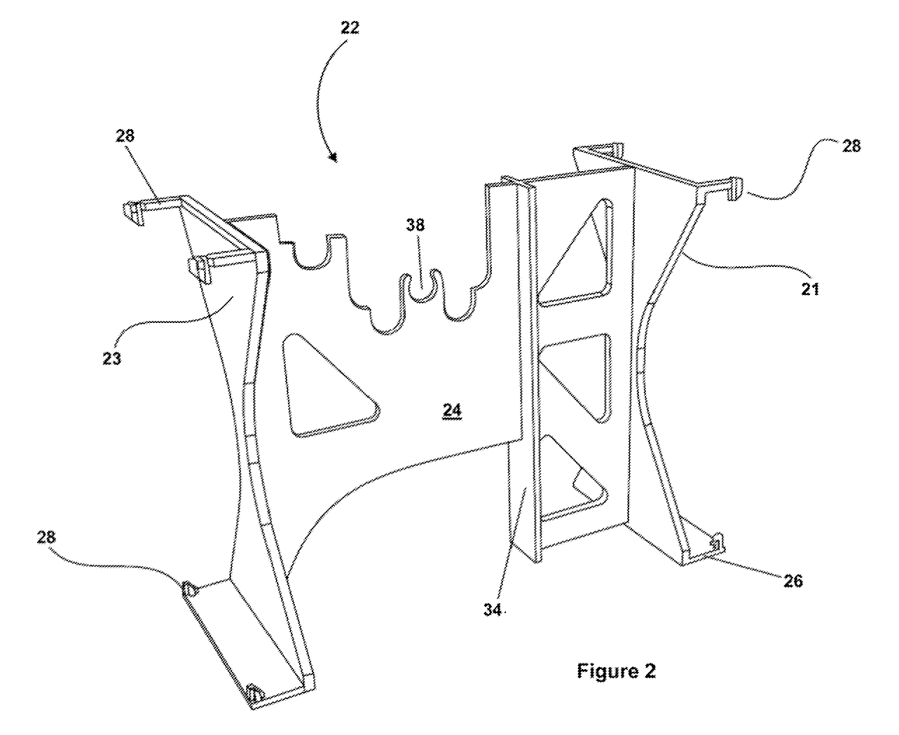

A rod 36, such as steel rebar, can be positioned between the first and second sides of the clip 22 and can be embedded in the pourable material. The connecting member 24 can include a connector for attaching to the steel rod 36, for example, the curved area 38 shown in FIG. 2, allows for reinforcing rod 36 to be locked in place.

Referring to FIG. 2 a perspective view of the clip 22 is shown. As discussed above, the clip 22 is utilized to interlock the block assemblies 12 and 14 (FIG. 1). The upper and lower brackets 26 and 27 of the clip can hold the blocks firmly. A piece of rigid insulation, such as a foam block, can be slipped into the interior of the blocks and can be held in place by the flange 34. The connecting member 24 is attached to the first side and second side of the clip 22 and the connecting member 24 is configured to hold the first and the second sides in a spaced apart parallel relationship, wherein a space cavity is provided between the first and second sides. A pourable material can be deposited between the first and second blocks assemblies 12 and 14 in liquid form wherein it can be allowed to solidify. The curved area 38 allows a reinforcing steel to be held in place.

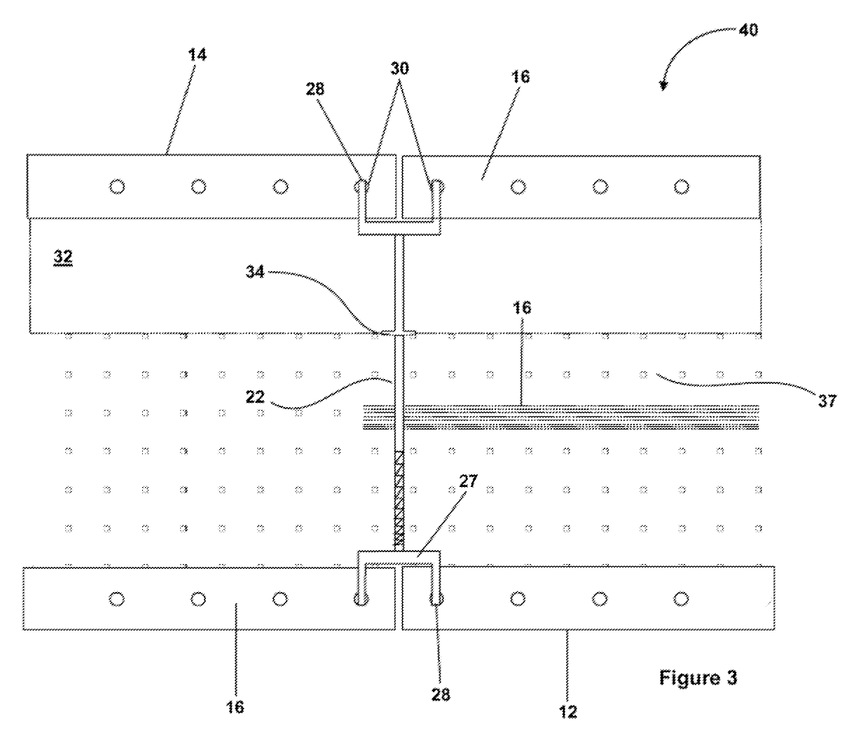

Now referring to FIG. 3 is substantially a top view 40 of the wall with the clip holding the blocks is shown in accordance with an embodiment of the present invention. The upper bracket 27 of the clip 22 holds the upper surface 16 of the block assemblies 12 and 14 firmly at the interface of the receptacles 30 and projections 28. The receptacles 30 of the blocks engage the projections 28 of the upper brackets 27 of the clip 22. The insulating block 32 is inserted between the first and second sides of the clip 22. A pourable, liquid-like material 37, such as concrete or cement, is deposited in the space between the first and second blocks assemblies 12 and 14. The reinforcing rod 36 and upper surface of the flange 34 are also shown in use in FIG. 3.

The process of wall construction can be summarized as follows. The site is excavated appropriately, such as by digging a trench and depositing gravel or sand into the trench. The surface is then compressed and leveled. The clip 22 holds the first and second blocks 12 and 14 and in a parallel spaced apart relationship on the surface. In an alternative embodiment, a concrete pad or footing is provided as the base of the wall. A plurality of layers of the blocks 12 and 14 and clips 22 may be constructed on top of each other to reach a desired height. An insulating block 32 may then be inserted between the first and second blocks 12 and 14 and held in place by a flange 34. A reinforcing rod 36 is placed in between the first and second blocks and is locked in place by the curved area 36. Finally a pourable material is filled in the cavity and is allowed to solidify.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A wall construction system comprising:
(A) at least a first and second block, each block comprising an upper surface, lower surface and an inner surface;
(B) at least one clip, the clip comprising:
(a) a first side configured to abut the inner surface of the first block and hold the first block in vertical alignment;
(b) a second side configured to abut the inner surface of the second block and hold the second block in vertical alignment;
(c) a connecting member attached to the first side and second side, the connecting member being configured to hold the first and the second sides in a spaced apart parallel relationship, wherein a cavity is provided between the first and second sides; and
(C) a pourable material between the first and second sides the pourable material being deposited between the first and second blocks in liquid form and allowed to solidify.

2. The wall construction system of claim 1 wherein the first and second side comprises a lower bracket, the lower bracket configured to abut the lower surface of the first block.

3. The wall construction system of claim 2 wherein the lower surface of the block comprises a receptacle and the lower bracket comprises a projection configured to engage the receptacle.

4. The wall construction system of claim 1 wherein the first and second side comprises an upper bracket, the upper bracket configured to abut the upper surface of the first block.

5. The wall construction system of claim 4 wherein the upper surface of the block comprises a receptacle and the upper bracket comprises a projection configured to engage the receptacle.

6. The wall construction system of claim 1 further comprises at least one insulating block, the insulating block being configured to be inserted between the first and second sides of the clip.

7. The wall constriction system of claim 6 wherein the insulating block comprises foam.

8. The wall construction system of claim 6 wherein the connecting member comprises a flange configured to support the insulating block.

9. The wall construction system of claim 1 further comprising a reinforcement member positioned between the first and second sides of the clip, wherein the reinforcement may be embedded in the pourable material.

10. The wall construction system of claim 9 wherein the connecting member comprises a connector for attaching to the reinforcement member.

11. The wall constriction system of claim 9 wherein the reinforcement member comprises a rod.

12. A clip for constructing a wall, the clip comprising:
(A) a first side configured to abut a surface of the first block and hold the first block;
(B) a second side configured to abut a surface of a second block and hold the second block in vertical alignment; and
(C) a connecting member attached to the first side and the second side; the connecting member being configured to hold the first and second sides in a spaced apart parallel relationship, wherein a cavity is provided between the first and second blocks, the cavity being configured to receive a pourable material between the first and second sides.

13. The clip of claim 12 wherein the connecting member comprises a flange for holding an insulating block between the first and second sides.

14. The clip of claim 12 further comprising a lower bracket attached to the first side, the lower bracket configured to support a lower surface of the first block.

15. The clip of claim 14 wherein the lower bracket comprises a projection for engaging a receptacle in the first block.

16. The clip of claim 12 further comprising an upper bracket attached to the first side, the upper bracket configured to abut an upper surface of the first block.

17. The clip of claim 16 wherein the upper bracket comprises a projection for engaging a receptacle in the first block.

18. The clip of claim 12 further comprising a connector for receiving a reinforcement member.

19. A method of constructing a wall, comprising, not all necessarily in the order shown:
(A) holding a first block using a clip;
(B) holding a second block using the clip, wherein the first and second blocks are held in a parallel spaced apart relationship;
(C) pouring a material into the cavity between the first and second blocks; and
(D) allowing the material to solidify.

20. The method of claim 19 further comprising inserting an insulating block between the first and second blocks before pouring the material into the cavity.

21. The method of claim 19 further comprising placing a reinforcement member in the cavity between the first and second blocks before pouring the material.

22. A clip comprising:
(A) a first attachment means for holding a first block;
(B) a second attachment means for holding a second block; and
(C) a spacing means for providing a cavity between the first and second blocks for receiving a pourable material.

23. A clip of claim 22 further comprising an internal holding means for holding an insulating block

24. The clip of claim 22 further comprising a connector means for attaching a reinforcement.
